(19) United States
(12) Patent Application Publication
(10) Pub. No.: US 2014/0354061 A1
(43) Pub. Date: Dec. 4, 2014

(54) POWER SUPPLY DEVICE AND SWITCH METHOD THEREOF

(71) Applicants: Inventec Corporation, Taipei City (TW); Inventec (Pudong) Technology Corporation, Shanghai (CN)

(72) Inventor: SING-HAO PENG, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 14/227,608

(22) Filed: Mar. 27, 2014

(30) Foreign Application Priority Data
May 31, 2013 (CN) 201310214997.6

(51) Int. Cl. H02J 4/00

(52) U.S. Cl. CPC H02J 4/00
USPC 307/80

(57) ABSTRACT

A power supply device includes a power supply unit, a switch unit, a discharge unit and a control unit. The power supply unit is for receiving a first power or a second power, for outputting a third power. The switch unit is coupled to the power supply unit, for receiving the first power and the second power and outputting one of them. The discharge unit is coupled to the power supply unit, for performing a discharge to the power supply unit based on a control signal. The control unit controls the switch unit for stopping outputting the first power to the power supply unit. The control unit generates the control signal so the discharge unit performs the discharge to the power supply unit for lowering the voltage of the power supply unit. The control unit controls the switch unit for outputting the second power to the power supply unit.

### CROSS-REFERENCE TO RELATED APPLICATIONS

This non-provisional application claims priority under 35 U.S.C. §119(a) on Patent Application No(s). 201310214997.6 filed in China, P.R.C. on May 31, 2013, the entire contents of which are hereby incorporated by reference.

### BACKGROUND OF THE INVENTION

1. Technical Field of the Invention

The disclosure relates to a power supply device and a switch method thereof, more particularly to a power supply device capable of switching different supply powers and having a discharge function, and a switch method thereof.

2. Description of the Related Art

In today's power supply device capable of switching power sources automatically, the primary thereof is switched between two AC powers. One of the AC powers is a common mains AC power, while the other one is the AC power generated by a backup alternator. Normally, the power supply device is running on the mains AC power as the default power. When the mains AC power is cut off, the control circuit of the device switches the power source to the AC power provided by the backup alternator.

However, switching from the mains AC power to the AC power of the alternator takes tens of seconds, which results in a brief power outage. Thus, in this approach, it is needed to add a backup device (e.g. a battery) or an uninterruptible power source (UPS) for stable power supply. This leads to extra costs and the backup device or the uninterruptible power source takes up large space. In addition, the whole system is inefficient with these extra devices.

### SUMMARY OF THE INVENTION

A power supply device comprises a power supply unit, a switch unit, a discharge unit and a control unit. The power supply unit is configured for receiving a first power or a second power, for outputting a third power. The switch unit is coupled to the power supply unit, for receiving the first power and the second power and outputting the first power or the second power. The discharge unit is coupled to the power supply unit, for performing a discharge to the power supply unit based on a control signal. The control unit is coupled to the switch unit and the discharge unit, for determining whether the voltage is less than a first voltage. The control unit controls the switch unit for stopping outputting the first power to the power supply unit. The control unit generates the control signal so that the discharge unit performs the discharge to the power supply unit for lowering the voltage of the power supply unit. The control unit controls the switch unit for outputting the second power to the power supply unit.

Moreover, a switch method for a power supply device comprises steps of: outputting a first power to a power supply unit; determining whether the voltage of the first power is less than a first voltage; stopping outputting the first power to the power supply unit when determining that the voltage of the first power is less than a first voltage; performing a discharge process; and outputting a second power to the power supply unit.

### BRIEF DESCRIPTION OF THE DRAWINGS

The present disclosure will become more fully understood from the detailed description given hereinbelow, along with the accompanying drawings which are for illustration only, thus are not limitative of the present disclosure, and wherein:

FIG. 1 is a schematic view of a power supply device;

FIG. 2 is a flow chart of a switch method of the power supply device;

FIG. 3 is a flow chart of S240 of FIG. 2; and

FIG. 4 is another schematic view of the power supply device.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

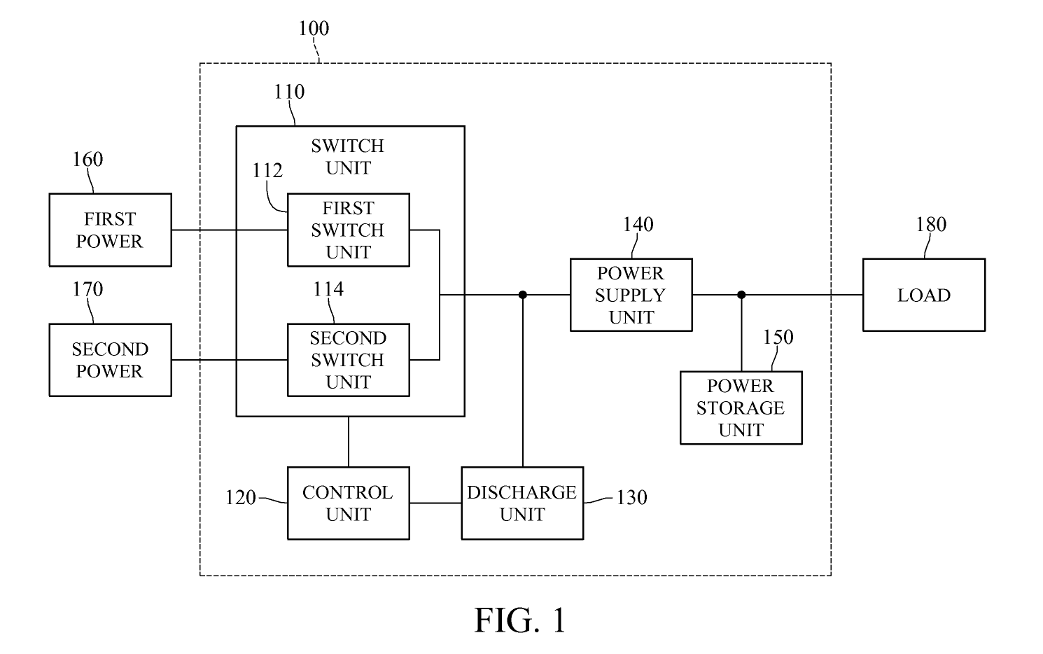

FIG. 1 is a schematic view of a power supply device. As seen in FIG. 1, the power supply device 100 comprises a switch unit 110, a control unit 120, a discharge unit 130 and a power supply unit 140. The switch unit 110 is used for receiving a first power 160 and a second power 170, for selectively outputting the first power 160 or the second power 170. The power supply unit 140 is coupled to the switch unit 110 for receiving the first power 160 or the second power 170 which are output by the switch unit 110. Furthermore, the power supply unit 140 is configured for changing the received first power 160 or the received second power 170 into a third power and outputting it to a load 180. The load 180, therefore, may use the third power.

In this embodiment, the switch unit 110 further comprises a first switch unit 112 and a second switch unit 114. The first switch unit 112 is coupled to the power supply unit 140 and is controlled by the control unit 120, for controlling whether the first power 160 is output to the power supply unit 140. The second switch unit 114 is coupled to the power supply unit 140 and is controlled by the control unit 120, for controlling whether the second power 170 is output to the power supply unit 140. The discharge unit 130 is coupled to the power supply unit 140 for performing a discharge to the power supply unit 140 based on a control signal.

The control unit 120 is coupled to the switch unit 110 and the discharge unit 130, for determining whether the voltage of the first power 160 is less than the first voltage. The control unit 120 controls the switch unit 110 for stopping outputting the first power 160 to the power supply unit 140, and the control unit 120 generates the control signal, so that the discharge unit 130 performs a discharge to the power supply unit 140 for lowering the voltage of the power supply unit 140. Moreover, the control unit 120 controls the switch unit 110 for outputting the second power 170 to the power supply unit 140.

Firstly, when the first power 160 outputs normally, the control unit 120 controls the switch unit 110 for selectively outputting the first power 160 to the power supply unit 140. Based on the first power 160, the power supply unit 140 generates the third power corresponding to the first power 160 to the load 180. Then, the control unit 120 determines the power supply condition of the first power 160. That is, the control unit 120 determines whether the first power 160 is less than the first voltage.

When determining that the first power 160 is less than the first voltage (e.g. the first power 160 is cut off), the control unit 120 controls the switch unit 110 for stopping outputting the first power 160 to the power supply unit 140. In other words, the control unit 120 controls the first switch unit 112 of the switch unit 110 to stop outputting the first power 160 to the power supply unit 140 by disconnecting the first power 160 from the power supply unit 140.

Subsequently, the control unit 120 controls the discharge unit 130 for performing the discharge to the power supply unit 140, which reduces the voltage of the power supply unit 140. In this embodiment, the first power 160 is, for example, an AC power or a mains power, while the discharge unit 130 is, for instance, a resistor or a dissipative element. However, the disclosure is not limited thereto.

Then, when the power supply unit 140 is lowered to a default value, the control unit 120 controls the switch unit 110 in order to selectively output the second power 170 to the power supply unit 140. Based on the second power 170, the power supply unit 140 generates the third power corresponding to the second power 170 to the load 180. In this embodiment, the second power 170 is, for example, a DC power while the load 180 is, for example, a server. Nonetheless, the disclosure is not limited thereto.

Moreover, in this embodiment, the power supply device 100 further comprises a power storage unit 150. The power storage unit 150 is coupled to the power supply unit 140 and the load 180 and is located between them, for stabilizing the voltage between the power supply unit 140 and the load 180. The power storage unit 150 is, for example, a battery, a capacitor or a storage element.

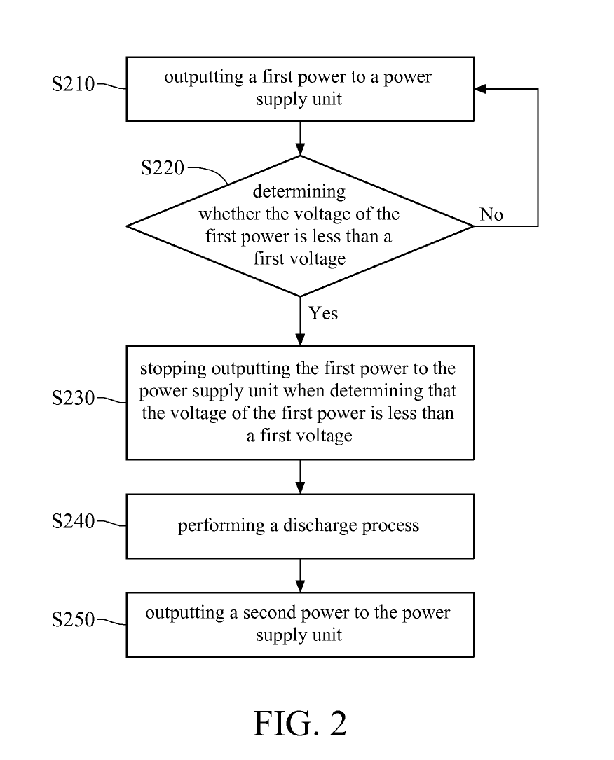

FIG. 2 is a flow chart of a switch method of the power supply device. As seen in FIG. 2, the power supply device 100 of the above-mentioned embodiment may perform this switch method. At first, the control unit 120 enables the first switch unit 112 for outputting the first power 160 to the power supply unit 140 (S210). Then, the control unit 120 determines that the voltage of the first power 160 is less than the first voltage (S220).

When determining that the voltage of the first power 160 is less than the first voltage, the control unit 120 controls the first switch unit 112 for stopping outputting the first power 160 to the power supply unit 140 (S230). That is, the control unit 120 disables the first switch unit 112 for disconnecting the power storage unit 150 from the power supply unit 140, so that the switch unit 110 does not output the first power 160. After disconnecting the first power 160 from the power supply unit 140, the power supply unit 140 still temporarily has a voltage close to the first power 160, and the control unit 120 controls the discharge unit 130 to perform a discharge process (S240)

Subsequently, the control unit 120 enables the second switch unit 114 to output the second power 170 to the power supply unit 140 (S250). After S250, when determining that the voltage of the first power 160 is greater than or equal to the first voltage, the process backs to S210. The control unit 120 still enables the first switch unit 112 to output the first power 160 to the power supply unit 140.

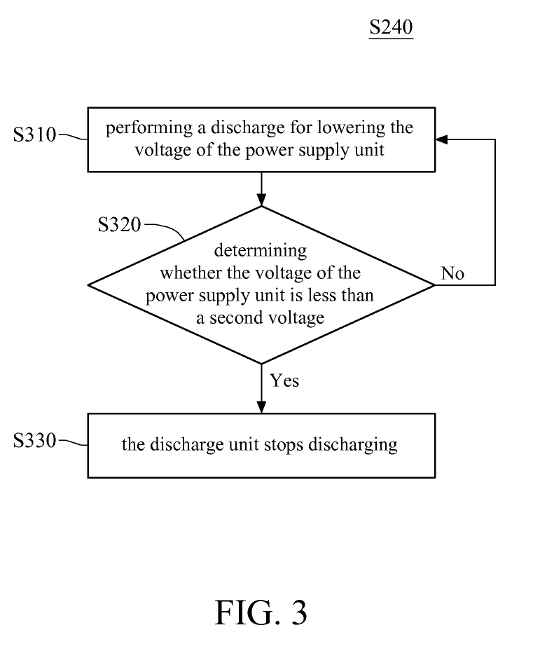

FIG. 3 is a flow chart of S240 of FIG. 2. As seen in FIG. 3, the control unit 120 controls the discharge unit 130 to perform the discharge process for lowering the voltage of the power supply unit 140. Then, the control unit 120 determines whether the voltage of the power supply unit 140 is less than the second voltage (S320).

When determining that the voltage of the power supply unit 140 is less than the second voltage, the control unit 120 controls the discharge unit 130 to stop discharging (S330). After S330, when determining that the voltage of the power supply unit 140 is greater or equal to the second voltage, it indicates the temporary voltage of the power supply unit 140 is not lowered to the second voltage yet, so the process backs to S310. The control unit 120 still controls the discharge unit 130 to perform the discharge process ceaselessly.

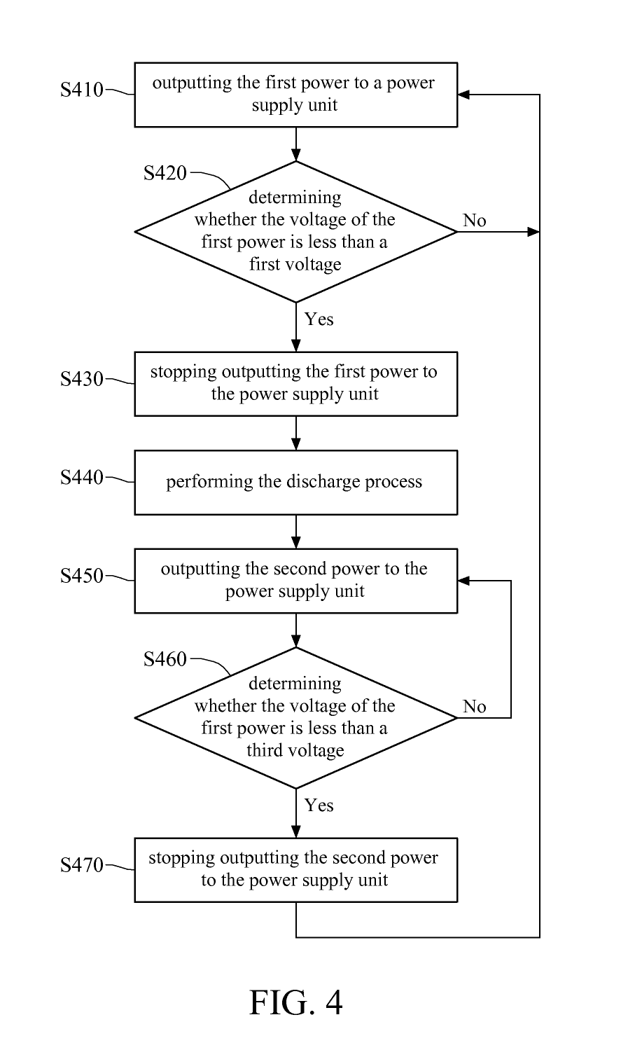

FIG. 4 is another schematic view of the power supply device. Firstly, as seen in FIG. 4, the control unit 120 enables the first switch unit 112 to output the first power 160 to the power supply unit 140 (S410). Subsequently, the control unit 120 determines whether the voltage of the first power 160 is less than the first voltage (S420). When determining that the voltage of the first power 160 is greater than or equal to the first voltage, the process backs to S410 where the control unit 120 keeps enabling the first switch unit 112 to output the first power 160 to the power supply unit 140.

On the other hand, when determining that the voltage of the first power 160 is less than the first voltage, the control unit 120 controls the first switch unit 112 to stop outputting the first power 160 to the power supply unit 140 (S430). Then, the control unit 120 controls the discharge unit 130 to perform the discharge process (S440). Subsequently, the control unit 120 enables the second switch unit 114 to output the second power 170 to the power supply unit 140 (S450).

Then, the control unit 120 further determines whether the voltage of the first power 160 is greater than a third voltage (S460). When the voltage of the first power 160 is less than or equal to the third voltage, it indicates the first power 160 not yet returns to normal condition so the process backs to S450 where the control unit 120 still enables the second switch unit 114 to output the first power 160 to the power supply unit 140 ceaselessly.

By comparison, when the voltage of the first power 160 is greater than the third voltage, the control unit 120 disables the second switch unit 114 to stop outputting the second power 170 to the power supply unit 140 (S470). After this, the process backs to S410 where the control unit 120 enables the first switch unit 112 again to selectively output the first power 160 to the power supply unit 140.

In the power supply device and the switch method thereof according to the aforementioned embodiments, the discharge process is performed when determining that the first power of the power supply unit is cut off, and the second power is switched to be output to the power supply unit. Thereby, this solves the problem of temporary power outage caused by switching between the two powers. Furthermore, this may also save costs of equipments and may improve the efficiency of the operation of the overall system.

What is claimed is:

1. A power supply device comprising:
a power supply unit being configured for receiving a first power or a second power, for outputting a third power;
a switch unit being coupled to the power supply unit, for receiving the first power and the second power and outputting the first power or the second power;
a discharge unit being coupled to the power supply unit, for performing a discharge to the power supply unit based on a control signal; and
a control unit being coupled to the switch unit and the discharge unit, for determining whether the voltage is less than a first voltage, wherein the control unit controls the switch unit for stopping outputting the first power to the power supply unit, the control unit generates the control signal so that the discharge unit performs the discharge to the power supply unit for lowering the voltage of the power supply unit, and the control unit controls the switch unit for outputting the second power to the power supply unit.

2. The power supply device according to claim 1, wherein when determining that the voltage of the first power is greater than or equal to the first voltage, the control unit controls the switch unit for outputting the first power to the power supply unit.

3. The power supply device according to claim 1, wherein the switch unit comprises:
a first switch unit being coupled to the power supply unit, for controlling whether the first power is output to the power supply unit; and
a second switch unit being coupled to the power supply unit, for controlling whether the second power is output to the power supply unit.

4. The power supply device according to claim 1, further comprising a power storage unit being coupled to the power supply unit, for stabilizing the voltage of the power supply unit.

5. The power supply device according to claim 1, wherein the first power is AC power while the second power is DC power.

6. A switch method for a power supply device, comprising steps of:
outputting a first power to a power supply unit;
determining whether the voltage of the first power is less than a first voltage;
stopping outputting the first power to the power supply unit when determining that the voltage of the first power is less than a first voltage;
performing a discharge process; and
outputting a second power to the power supply unit.

7. The switch method for a power supply device according to claim 6, further comprising:
outputting the first power to the power supply unit when determining that the voltage of the first power is greater than or equal to the first voltage.

8. The switch method for a power supply device according to claim 7, wherein the discharge process comprising steps of:
performing a discharge for lowering the voltage of the power supply unit;
determining whether the voltage of the power supply unit is less than a second voltage;
stopping performing the discharge when determining that the voltage of the power supply unit is less than the second voltage; and
outputting the second power to the power supply unit when determining that the voltage of the power supply unit is greater than or equal to the second voltage.

9. The switch method for a power supply device according to claim 8, wherein outputting the second power to the power supply unit comprises steps of:
determining whether the voltage of the first power is less than a third voltage;
stopping outputting the second power to the power supply unit when the voltage of the first power is greater than the third voltage; and
outputting the second power to the power supply unit when the voltage of the first power is less than or equal to the third voltage.

10. The switch method for a power supply device according to claim 9, wherein stopping outputting the second power to the power supply unit comprises a step of;
outputting the first power to the power supply unit.
